(19) United States
(12) Patent Application Publication
(10) Pub. No.: US 2019/0072709 A1
(43) Pub. Date: Mar. 7, 2019

(54) LED PANEL LIGHT

(71) Applicant: GE Lighting Solutions, LLC, East Cleveland, OH (US)

(72) Inventors: Junqi REN, Shanghai (CN); Shouyong ZHOU, Shanghai (CN); Bing ZHANG, Shanghai (CN); Bin LI, Shanghai (CN); Cuijuan ZHOU, Shanghai (CN); Honglei GAO, Shanghai (CN)

(21) Appl. No.: 16/054,529

(22) Filed: Aug. 3, 2018

(30) Foreign Application Priority Data
Sep. 7, 2017 (CN) 201710800370.7

(51) Int. Cl. F21V 8/00; G02B 6/36; H05B 33/08

(52) U.S. Cl. CPC G02B 6/0073; G02B 6/0051; G09G 3/32; G02B 6/3616; H05B 33/0803; G02B 6/0055

(57) ABSTRACT

The present invention discloses an LED panel light, including at least one light source module, an LED driver for powering the at least one light source module, and a light guide, where each light source module includes an LED light bar including a plurality of light emitting diodes and a light bar holder; the light bar holder includes a first fixing surface, a second fixing surface, and a mounting surface connecting the first fixing surface and the second fixing surface; the first fixing surface, the second fixing surface, and the mounting surface together form a groove; and the LED light bar is mounted on the mounting surface. The groove of the light bar holder of the at least one light source module is designed to receive at least one side of the light guide; the at least one side of the light guide is so positioned in the groove that a distance between the at least one side of the light guide and individual light emitting diode maintains to be a predetermined distance which is independent of deformation of the light guide.

### TECHNICAL FIELD

The present invention relates to lighting technologies, and in particular, to an LED panel light.

### BACKGROUND

The LED (Light Emitting Diode) lighting technology has been widely used because of its advantages such as power saving, high brightness, long service life, and good seismic performance. An LED panel light is a newly developed lamp integrating lighting and decoration in the field of LED lighting. The principle of the lamp is to convert a line source into an area light source to realize plane illumination, and the lamp has the advantages of good illumination effect, attractive appearance, and great ornamental features.

However, current LED panel lights include a light guide for converting a line source into an area light source. In the prior art, the light guide is generally made of a polymethyl methacrylate (PMMA) material. Because of the intrinsic property of the material, the light guide is sensitive to environmental factors such as temperature and humidity, that is, the light guide may expand or shrink with the environmental factors, thereby affecting the luminous efficiency of the LED panel light, or even completely damaging the LED panel light.

Therefore, it is necessary to provide a method to solve the above problem.

### SUMMARY

An aspect of the present invention provides an LED panel light, which includes: at least one light source module (120), an LED driver (110) for powering the at least one light source module (120), and a light guide (131). Each of the at least one light source module (120) includes an LED light bar (121) including a plurality of light emitting diodes and a light bar holder (122), where the light bar holder (122) includes a first fixing surface, a second fixing surface, and a mounting surface connecting the first fixing surface and the second fixing surface; the first fixing surface, the second fixing surface, and the mounting surface together form a groove; and the LED light bar (121) is mounted on the mounting surface. The groove of the light bar holder (122) of the at least one light source module is designed to receive at least one side of the light guide (131); the at least one side of the light guide (131) is so positioned in the groove that a distance between the at least one side of the light guide (131) and individual light emitting diode maintains to be a predetermined distance which is independent of deformation of the light guide (131).

### BRIEF DESCRIPTION OF DRAWINGS

These and other features, aspects and advantages of the present invention will become better understood when the following detailed description is read with reference to the accompanying drawings, in which like reference numerals are used throughout the drawings to refer to like parts, where:

FIG. 1 is an exploded view of one embodiment of an LED panel light according to the present invention;

FIG. 2 is a schematic view of assembly of a light guide and a light source module according to an embodiment of the present invention;

FIG. 3 is a sectional view of the assembled view in FIG. 2 taken along section line AA′;

FIG. 4 is a schematic structural view of a light source module according to an embodiment of the present invention; and

FIG. 5 is a partially enlarged view of the assembled view in FIG. 2, a first fixing surface of the light bar holder being hidden for clarity of the internal structure.

### DETAILED DESCRIPTION

The specific embodiments of the present invention will be described in detail below with reference to the accompanying drawings in order to facilitate those skilled in the art to fully understand the subject matter claimed by the present invention. In the following detailed description of these specific embodiments, the present specification does not describe in detail any of the known functions or configurations, to avoid unnecessary details that may affect the disclosure of the present invention.

Unless otherwise defined, the technical and scientific terms used in the claims and the specification are as they are usually understood by those skilled in the art to which the present invention pertains. “First”, “second” and similar words used in the specification and the claims do not denote any order, quantity or importance, but are merely intended to distinguish between different constituents. The terms “one”, “a” and similar words are not meant to be limiting, but rather denote the presence of at least one. “Comprising”, “consisting of” and similar words mean that the elements or articles appearing before “comprising” or “consisting of” include the elements or articles and their equivalent elements appearing behind “comprising” or “consisting of”, not excluding any other elements or articles. “Connected”, “coupled” and similar words are not restricted to physical or mechanical connections, but may also include electrical connections, whether direct or indirect.

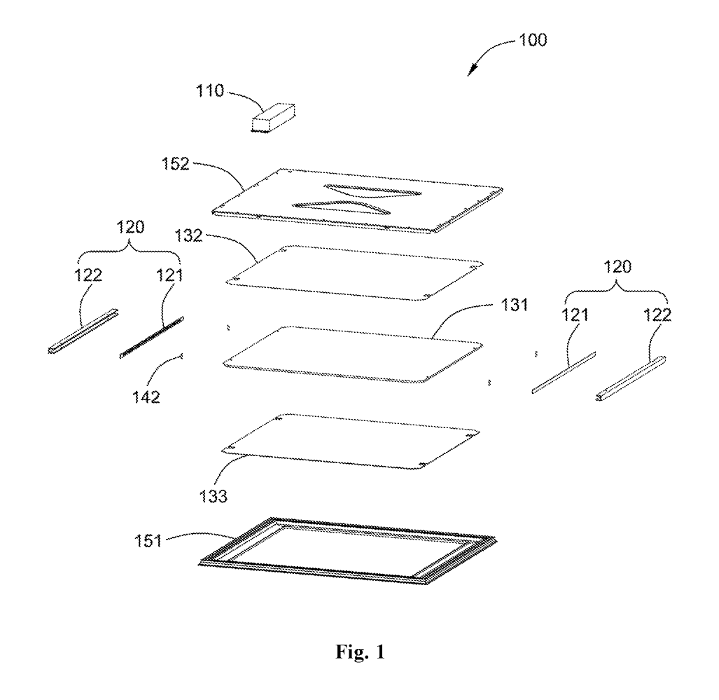

FIG. 1 is an exploded view of one embodiment of an LED panel light 100. As shown in FIG. 1, the LED panel light 100 includes at least one light source module 120, an LED driver 110, a light guide 131, a reflective film 132 and a diffuser plate 133, and a bazel 151 and a backboard 152 for providing support and protection for the above components. The LED driver 110 is configured to power the at least one light source module 120. The reflective film 132 is disposed on a rear surface of the light guide 131, and the diffuser plate 133 is disposed on a front surface of the light guide 131. During operation, at least one light source module 120 emits light toward the side of the light guide 131, and the light guide 131 emits the incident light from the front surface after multiple reflections so as to achieve surface illumination. The reflective film 132 is configured to reflect the light leaking from the rear surface of the light guide 131 again into the light guide 131, thereby improving the light utilization. The diffuser plate 133 is configured to emit light emitted from the front surface of the light guide 131 in a uniform brightness distribution, thereby improving uniformity and softness of the light emitted by the LED panel light 100. The light guide 131 can have different shapes as required. For example, in a specific embodiment, the light guide is a light guide plate, that is, a flat plate structure, but is not limited thereto.

In an existing technical solution, the LED light bar as a light source is often directly fixedly mounted inside the bazel, and the light guide 131 using the PMMA material is sensitive to environmental factors such as temperature and humidity. If the light guide 131 shrinks due to environmental factors, a distance between the light source and the light guide 131 is increased, thereby greatly reducing the luminous efficiency of the LED panel light; and if the light guide 131 expands due to environmental factors, the light source is highly likely to be squeezed, causing complete destruction of the LED light bar. Therefore, the present invention provides the technical solution of mounting the LED light bar on the side of the light guide 131 through the light bar holder, such that even if the light guide 131 is deformed due to an environmental factor, it can be ensured that the distance between the LED light bar and the side of the light guide 131 is not affected by the deformation of the light guide 131.

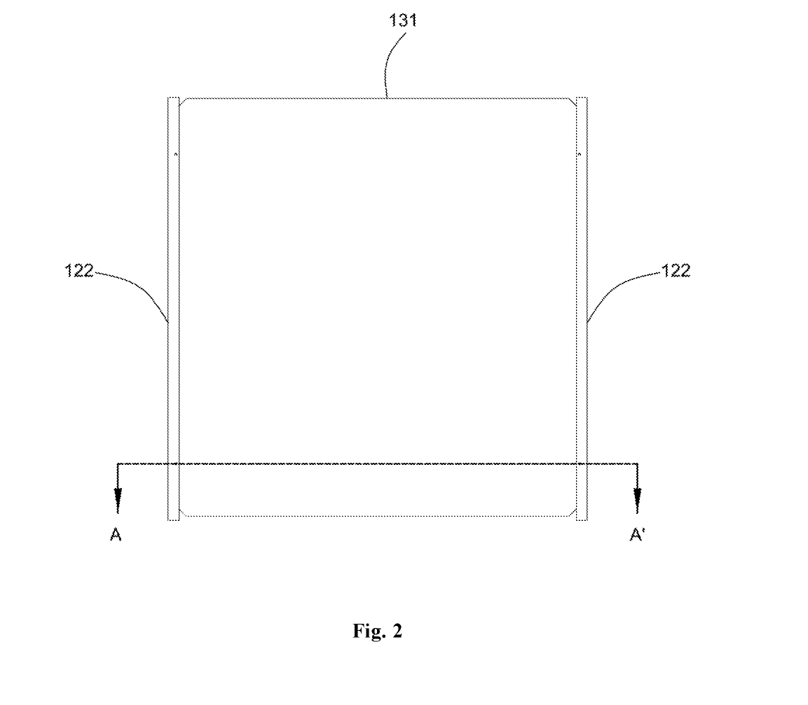

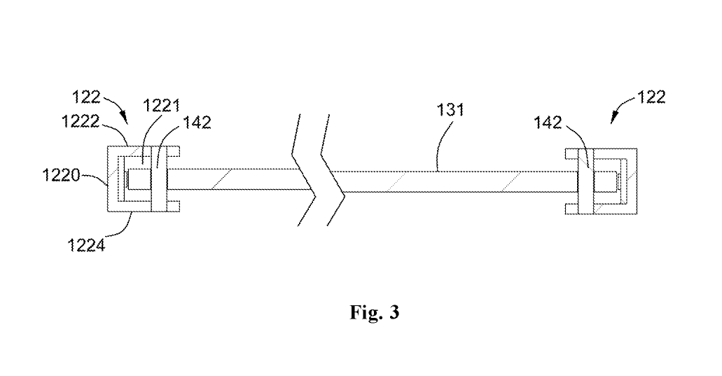

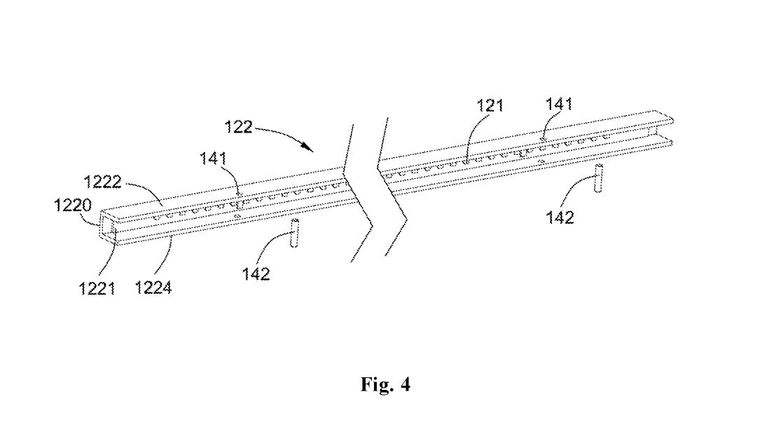

The following will describe in detail the LED panel light 100 of the present invention with reference to FIG. 1 to FIG. 5. Each light source module 120 includes an LED light bar 121 including a plurality of light emitting diodes and a light bar holder 122. As show in FIG. 4, the light bar holder 122 includes a first fixing surface 1222, a second fixing surface 1224, and a mounting surface 1220 connecting the first fixing surface 1222 and the second fixing surface 1224, and the first fixing surface 1222, the second fixing surface 1224, and the mounting surface 1220 together form a groove 1221. The LED light bar 121 is disposed at the bottom of the groove 1221, that is, on the side of the mounting surface facing the groove 1221. The LED light bar 121 and the light bar holder 122 are assembled to form one light source module 120. The number of light source modules 120 can be set as required, for example, one, two, and the like. In a specific embodiment, two light source modules 120 are provided, and the two light source modules 120 can be mounted on opposite sides of the light guide 131 in a manner shown in FIG. 2. In another embodiment, two light source modules 120 may also be disposed on two adjacent sides of the light guide 131. FIG. 3 shows a connection relationship between the at least one light source module 120 and the light guide 131. As shown in the figure, the groove 1221 of the light bar holder 122 is mounted for receiving the side of the light guide 131, and when the side of the light guide 131 is received in the groove 1221, the side of the light guide 131 maintains a predetermined distance from the LED. The predetermined distance is a value selected based on the luminous efficiency of the LED panel light 100, for example, the predetermined distance is in a range of 0-0.3 mm, and the predetermined distance is not affected by the deformation of the light guide 131.

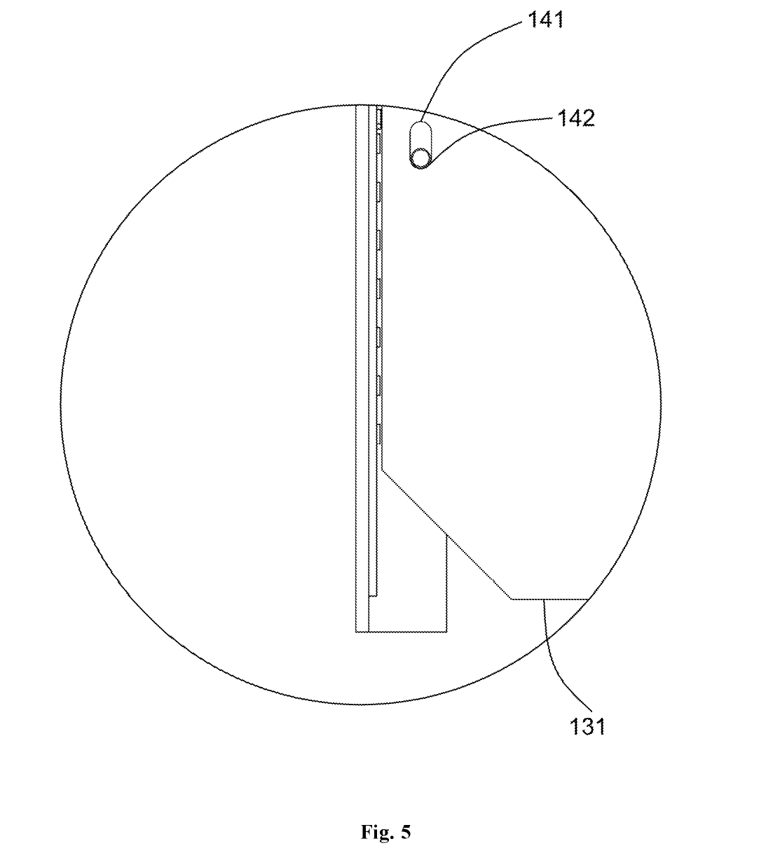

Then, the reason why the distance between the side of the light guide 131 and the LED is not affected by the deformation of the light guide 131 is explained. FIG. 5 shows a partially enlarged view of the assembly of at least one light source module 120 and the light guide 131, where a first fixing surface 1222 of the light bar holder 122 is hidden. As shown in the figure, the light bar holder 122 is connected with the light guide 131 through at least one dowel hole 141 and at least one dowel 142. The at least one dowel hole 141 is set on the first fixing surface 1222 and the second fixing surface 1224 of the light bar holder 122 and the light guide 131, and the at least one dowel 142 is installed inside the at least one dowel hole 141, that is, the at least one dowel 142 is installed in a manner of penetrating the first fixing surface 1222 and the second fixing surface 1224 of the light bar holder 122 and the light guide 131 shown in FIG. 3, so as to connect the light bar holder 122 with the light guide 131.

In the present invention, as shown in FIG. 5, the at least one dowel hole 141 is an elliptical hole including a long axis and a short axis, where the long axis is in parallel with the light bar holder 122, and a width of the short axis is equal to a width of the at least one dowel 142. A distance between the at least one dowel hole 141 and the side of the light guide 131 is a predetermined value. More particularly, the predetermined value is in a range of 1.7-2 mm. In this technical solution, since the width of the short axis is equal to the width of the at least one dowel 142, it is ensured that the light bar holder 122 remains relatively stationary with the light guide 131 in the short axis direction, that is, when the light guide 131 is deformed due to an environmental factor, for example, the light guide 131 expands or shrinks, the light bar holder 122 may move accordingly. In the long axis direction, the length of the at least one dowel hole 141 is greater than the width of the at least one dowel 142, such that the deformation of the light guide 131 in the long axis direction can be absorbed.

Further, the material of the light bar holder 122 may be galvanized steel plate, stainless steel, pure aluminum, or aluminum alloy. More particularly, the polycarbonate (PC) with an expansion or extension coefficient closest to that of the light guide 131 is used.

While the present invention has been described in detail with reference to specific embodiments thereof, it will be understood by those skilled in the art that many modifications and variations can be made in the present invention. It is, therefore, to be understood that the appended claims are intended to cover all such modifications and variations insofar as they are within the true spirit and scope of the invention.

1. An LED panel light comprising:
at least one light source module, each of the at least one light source module comprising an LED light bar comprising a plurality of light emitting diodes and a light bar holder, wherein the light bar holder comprises a first fixing surface, a second fixing surface, and a mounting surface connecting the first fixing surface and the second fixing surface;
the first fixing surface, the second fixing surface, and the mounting surface together form a groove; and the LED light bar is mounted on the mounting surface;
an LED driver for powering the at least one light source module; and a light guide, wherein
the groove of the light bar holder of the at least one light source module is designed to receive at least one side of the light guide; and
the at least one side of the light guide is so positioned in the groove that a distance between the at least one side of the light guide and individual light emitting diode maintains to be a predetermined distance which is independent of deformation of the light guide.

2. The LED panel light as claimed in claim 1, wherein the predetermined distance is in a range of 0-0.3 mm.

3. The LED panel light as claimed in claim 1, wherein the light bar holder is connected with the light guide through at least one dowel hole and at least one dowel.

4. The LED panel light as claimed in claim 3, wherein the at least one dowel hole is set on the first fixing surface, the second fixing surface, and the light guide, and the at least one dowel is installed inside the at least one dowel hole.

5. The LED panel light as claimed in claim 4, wherein the at least one dowel hole is an elliptical hole comprising a long axis and a short axis, wherein the long axis is in parallel with the light bar holder and a width of the short axis is equal to a width of the at least one dowel.

6. The LED panel light as claimed in claim 5, wherein a distance between the at least one dowel hole and the side of the light guide is configured to be a predetermined value.

7. The LED panel light as claimed in claim 6, wherein the predetermined value is in a range of 1.7-2 mm.

8. The LED panel light as claimed in claim 1, wherein the at least one light source module comprises two light source modules which are arranged at adjacent neighboring sides or two opposite sides of the light guide.

9. The LED panel light as claimed in claim 1, further comprising a reflective film and a diffuser plate, wherein the reflective film is configured to reflect light leaking from a rear surface of the light guide, and the diffuser plate is configured to emit light emitted from a front surface of the light guide in a uniform brightness distribution.

10. The LED panel light as claimed in claim 1, wherein the light bar holder is made of polycarbonate and the light guide is a light guide plate.
